(19) United States
(12) Patent Application Publication
(10) Pub. No.: US 2006/0202510 A1
(43) Pub. Date: Sep. 14, 2006

(54) Loading floor

(75) Inventors: Frans Arian Heino De Raad, Coevorden (NL); Nicolaas Marc Mater, Hengelo (NL)

Correspondence Address: LADAS & PARRY, 26 WEST 61ST STREET, NEW YORK, NY, 10023, US

(73) Assignee: CARGO FLOOR B.V.

(21) Appl. No.: 11/341,916

(22) Filed: Jan. 27, 2006

(30) Foreign Application Priority Data
Jan. 28, 2005 (NL) 1028144

(51) Int. Cl. B62D 25/20

(52) U.S. Cl. 296/184.1

(57) ABSTRACT

Floor of loading, unloading and/or storage spaces, for instance of trucks, comprising a number of slats that are reciprocally movable in loading/unloading direction by means of a drive, a series of cross beams supporting the slats and a number of fixedly positioned main girders extending in the loading/unloading direction and supporting the floor with drive, wherein the cross beams have an upper surface situated below the upper surface of the main girders, wherein series of support/guides for the slats have been attached to the cross beams, wherein the support/guides hold the slats with the lower side of the slats above the upper surface of the main girders.

The invention relates to a floor of loading, unloading and/or storage spaces, such as truck floors and industrial floors, wherein the floor comprises a series of adjacently placed slats that are reciprocally movable in groups.

It is known to support the slats in such floors on longitudinal tubes extending in slat direction, one for each slat, and supported by cross beams, which in turn are supported on longitudinal girders, which, in one arrangement (centre frame), have been arranged like chassis main girders underneath the cross beams, spaced apart from the longitudinal sides of the loading space and the like. In another arrangement (perimeter frame) the longitudinal girders are situated at the sides of the loading space and the like, In both arrangements the short guides for the slats can be placed on the said longitudinal tubes, at the location of the crossings with the cross beams.

It is known, in particular in case of a centre frame arrangement, to place the cross beams in a lowered position, wherein the upper side of the cross beams is situated below the upper side of the main girders. Such arrangements are also characterised by the indication “passed through girders”. In order not to create a discontinuity in the slat floor at the location of the main girders, the cross beams are heightened by welding customised tubes or other profiles thereon. The said longitudinal tubes that support and guide the slats are subsequently attached to said tube. This arrangement requires a lot of material and labour.

It is an object of the invention to provide a floor of the type mentioned in the preamble, in which an arrangement with so-called passed through girders is realised in another way.

It is an object of the invention to provide a floor of the type mentioned in the preamble in which an arrangement with so-called passed through girders is realised in a simpler way.

From one aspect the invention provides a floor of loading, unloading and/or storage spaces, for instance of trucks, comprising a number of slats that are reciprocally movable in loading/unloading direction by means of a drive, a series of cross beams supporting the slats and a number of fixedly positioned main girders extending in the loading/unloading direction and supporting the floor with drive, wherein the cross beams have an upper surface situated below the upper surface of the main girders, wherein series of support/guides for the slats have been attached to the cross beams, wherein the support/guides hold the slats with the lower side of the slats above the upper surface of the main girders, In that way despite the low position of the cross beams, the slats can be supported at the right height, without additional tubes on the cross beams and longitudinal tubes being necessary.

In a preferred embodiment the cross beams have an upper wall, of which the upper surface is situated below the lower surface of an upper wall of the main girder.

In an embodiment as centre frame, the cross beams then extend beyond the main girders in transverse direction of the floor.

In an embodiment the cross beams are less high than the main girders and the cross beams have a lower surface that is situated above the lower surface of the main girders.

In an embodiment the support/guides each comprise a base part placed on the cross beam in question, a support part supporting the slat in question, as well as an intermediate part connecting the base part and the support part with each other. The desired height of the support surface for the slats may particularly be realised by means of the intermediate part. The base part, the intermediate part and the support part may form one unity with each other, preferably are formed as one unity with each other, particularly through injection moulding of synthetic material. When manufacturing the height of the intermediate part can be adjusted to the height dimensions that are usual for passed through girders.

In one embodiment the support part is situated entirely above the upper surface of the main girders.

The height of the base part with intermediate part may be larger than the height of the support part.

The slats may form hollow profiles having an upper wall, side walls extending downward therefrom and lower flanges extending inward from the lower edge of the side walls, wherein the lower flanges extend below the support parts. The support part may in a direction transverse or parallel, respectively, to the slats be widened with respect to the intermediate part.

The attachment of the support/guides is facilitated when the cross beams have an upper wall having a lower surface, wherein the support/guides with integrally formed attachment members engage below the upper wall and against its lower surface.

In a first embodiment thereof the integrally formed attachment members are designed for a snap action, making in a quick placement possible. The attachment members providing snap action may extend through a hole made in the cross beam.

In a second embodiment the attachment members comprise a flange. The flange may form a U-shaped accommodation space in which at least a part of the upper wall of the cross beam has been accommodated. The support/guide may in that case be provided with two pendent confinement strips confining the upper wall of the cross beam between them, wherein the flange is integrally formed at one of the confinement strips. In that way the support/guide can be hooked about the upper wall of the cross beam, in particular with I-profile, Z-profile (having a vertical web) or tilted U-profile.

From a further aspect the invention provides a floor of loading, unloading and/or storage spaces, for instance of trucks, comprising a number of slats that are reciprocally movable in loading/unloading direction by means of a drive, two fixedly positioned main girders extending in the loading/unloading direction and supporting the floor with drive and a series of cross beams supporting the slats, wherein the main girders comprise a vertical wall, such as a web of an I-girder, and the cross beams comprise portions that have been attached to either side of the vertical walls of the main girders, wherein the cross beams have an upper surface situated below the upper surface of the main girders, wherein each cross beam is provided with a separate series of support/guides for the slats, which support/guides have directly been attached to the upper surface of the cross beam in question and with a slat support surface extend above the upper surface of the main girders. Preferably the slats are situated entirely above the upper surface of the main girders.

In one embodiment the support/guides are single, so that they are easy to arrange at the desired location, without having to be made to size in horizontal direction, when placed.

Alternatively the support/guides can be formed like a joined (part) series in the longitudinal direction of the cross beam, as a result of which placement can take place per series and optionally fewer attachment points may suffice.

From a further aspect the invention provides a support/guide for reciprocally movable slats, comprising a support part for a slat and a base part to be placed on a girder or beam of a loading, unloading or storage floor, wherein the base part at its lower side is provided with integrally formed attachment members providing a snap connection in an attachment hole made in the girder or beam.

In one embodiment the attachment members have snap lips and between them a passage for accommodation of a core locking the snap lips, by which means an inadvertent springing back of the snap lips in the snap position is prevented.

From a further aspect the invention provides a support/guide for reciprocally movable slats, comprising a support part for a slat and a base part to be placed on a girder or beam of a loading, unloading or storage floor, wherein the base part at its lower side is provided with at least one lip for engaging about/below an upper flange or upper wall of the beam or girder. The support/guide can simply be placed on the beam or girder, in one embodiment with one lip from a direction transverse to the beam or girder, In another embodiment the support/guide is provided with two oppositely oriented lips, which between them define a passage for the web of the beam or girder. The support/guide can be slid on the beam or girder in the longitudinal direction thereof.

The invention furthermore provides a support/guide for reciprocally movable slats, suitable and intended for a floor according to the invention.

It is noted that from U.S. patent application 2003/0168318 a loading floor with reciprocally movable slats is known, wherein the slats are supported on cross beams of a loading floor by means of guides, which cross beams themselves are supported on top of a chassis girder.

U.S. Pat. No. 4,534,589 regards a rigid, immobile floor plate forming one unity of a loading floor that is supported on cross beams that haven been sunk in the main girders of the chassis.

The aspects and measures described in this description and claims of the application and/or shown in the drawings of this application may where possible also be used individually. Said individual aspects, such as the snap attachment of a support/guide in a hole in a girder or beam and the support/guide provided with a lip at the lower side, and other aspects may be the subject of divisional patent applications related thereto. This particularly applies to the measures and aspects that have been described in the sub claims.

The invention will be elucidated on the basis of a number of exemplary embodiments shown in the attached drawings, in which:

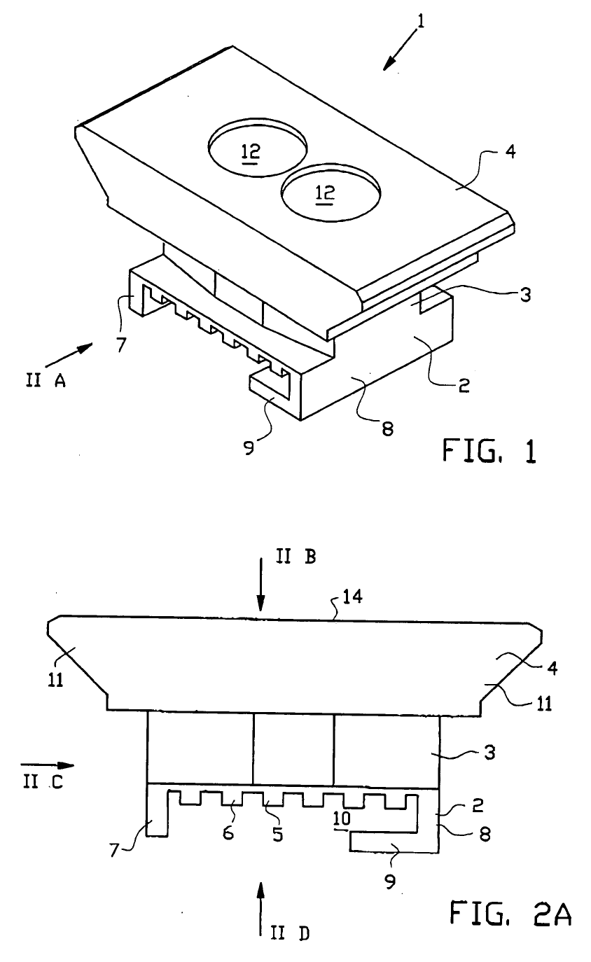

FIG. 1 shows a first exemplary embodiment of a slat support/guide according to the invention;

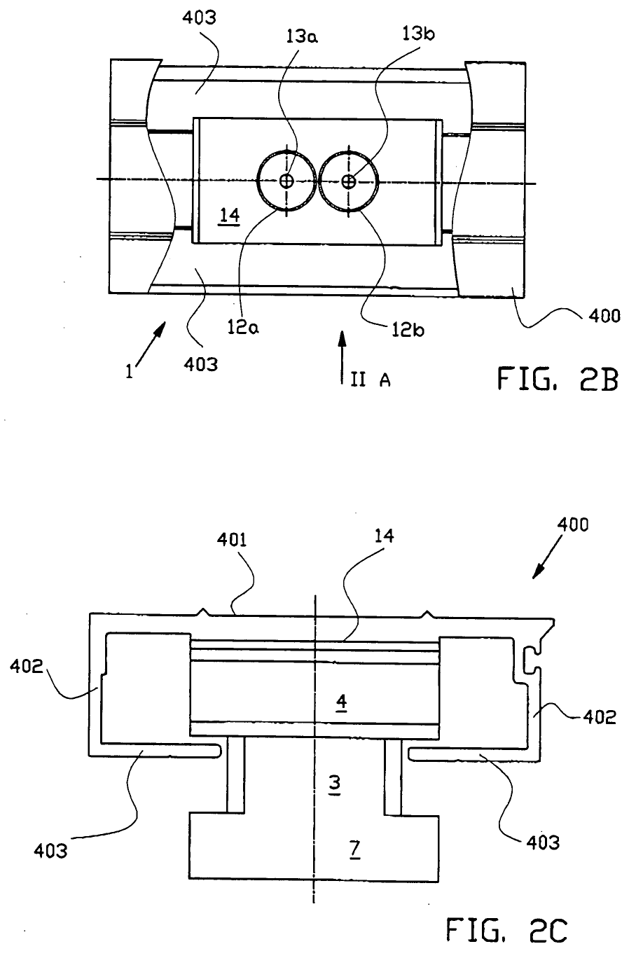

FIGS. 2A-D show a front view, a top view, a side view and a bottom view, respectively, of the guide of FIG. 1, the FIGS. 2B and 2C including a slat in the drawing;

FIG. 2E shows the guide of FIG. 1, seen diagonally from below;

FIG. 2F shows a detail at the lower side of the guide of FIG. 1;

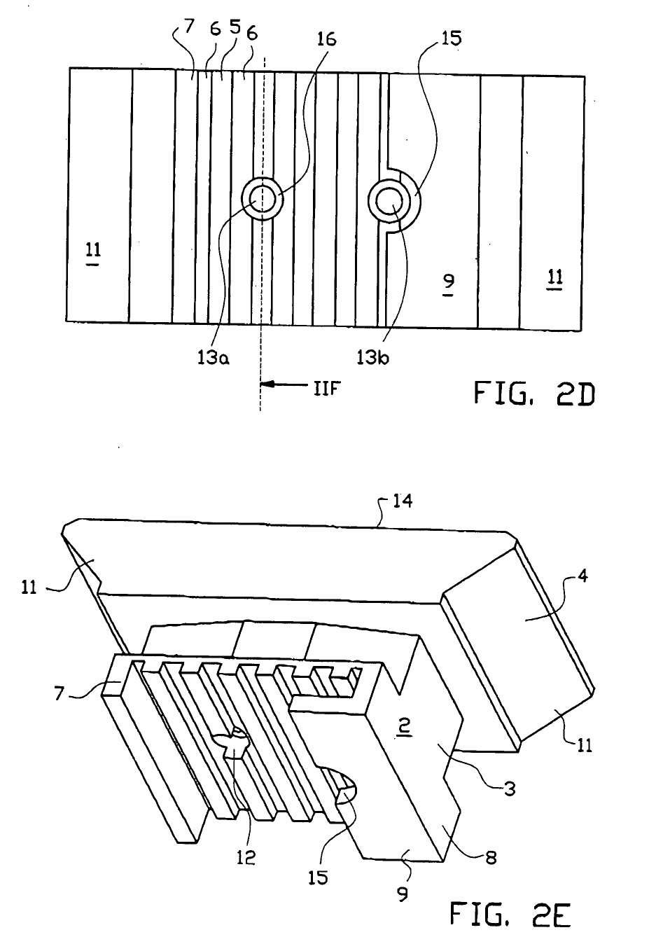

FIG. 3 shows a second exemplary embodiment of a slat support/guide according to the invention;

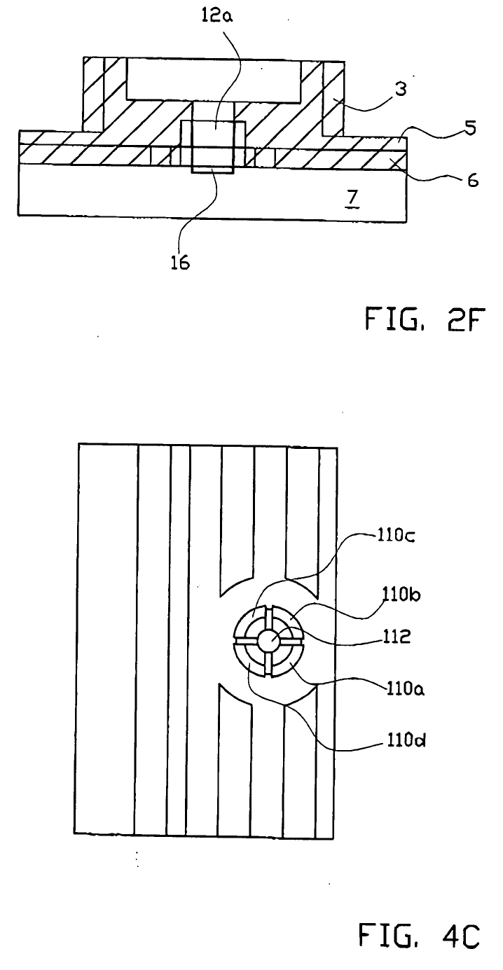

FIGS. 4A, 4B and 4C show a front view, a side view and a bottom view, respectively, of the guide of FIG. 3;

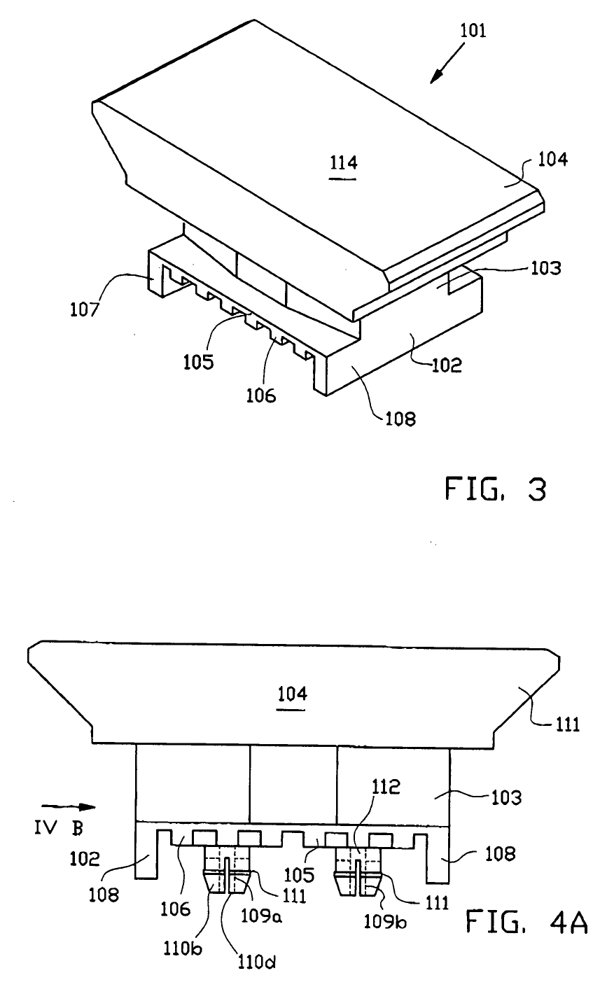

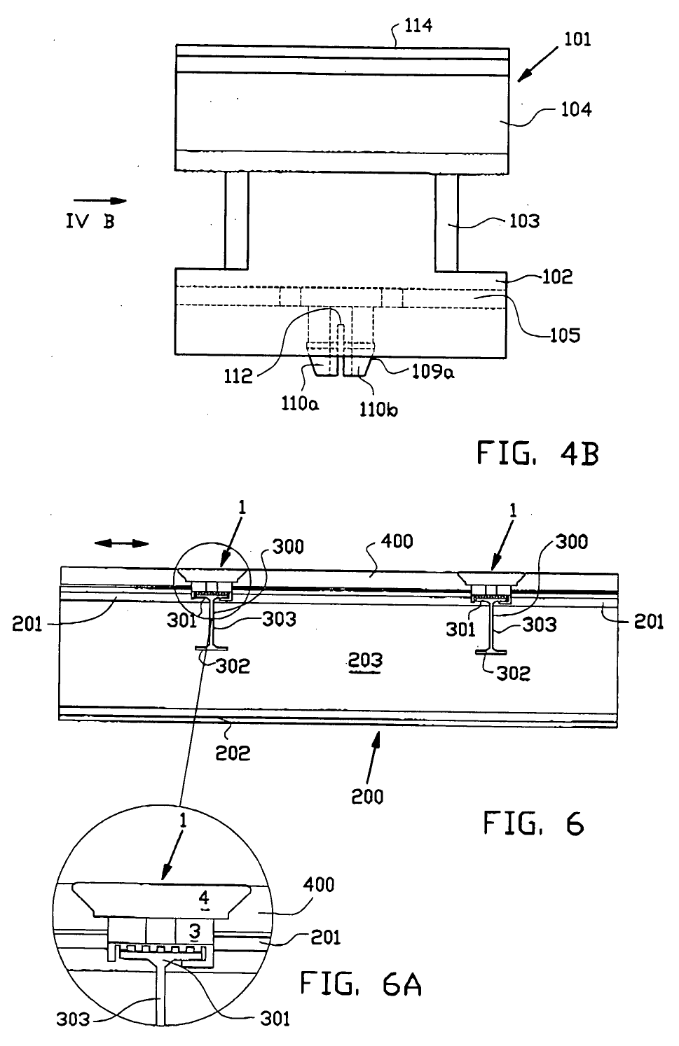

FIGS. 5 and 6 show a longitudinal view and a transverse view, respectively, of a floor according to the invention; and

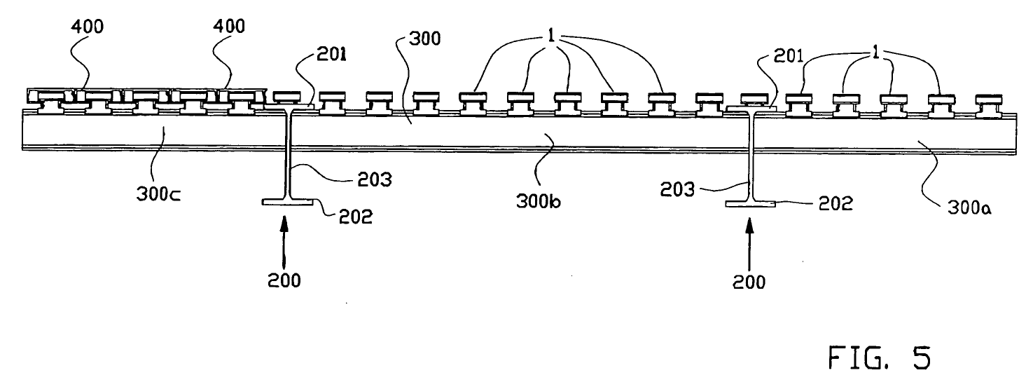

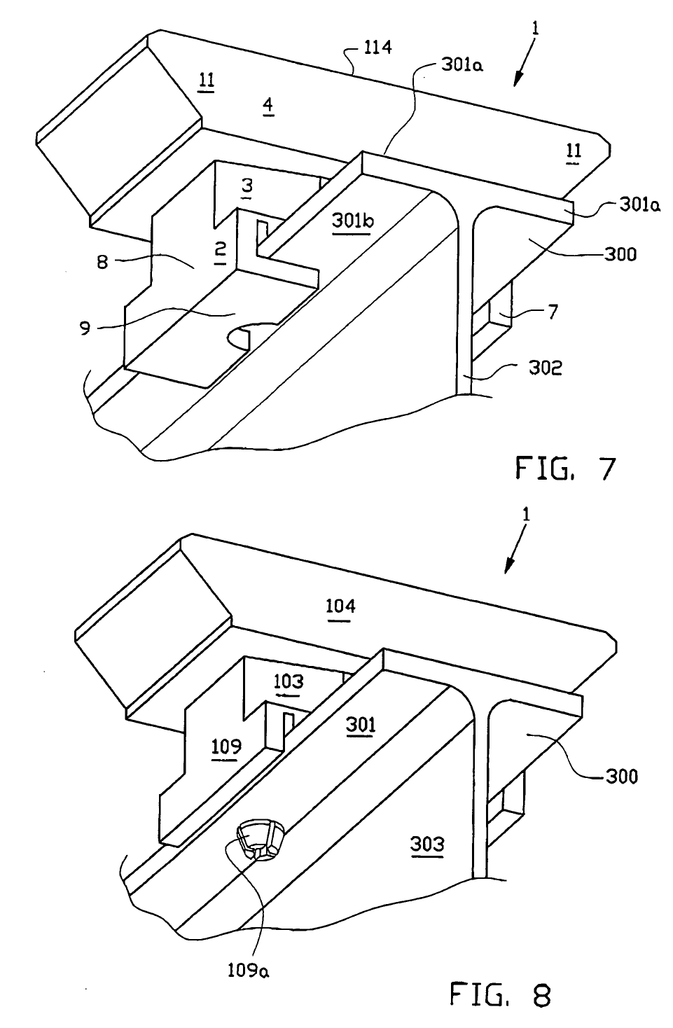

FIGS. 7 and 8 show diagonal bottom views of the placement of guides according to the FIGS. 1 and 3, respectively, on a cross beam in a floor according to the invention.

The support/guide 1 in FIG. 1 is formed as one unity by injection moulding of a suitable synthetic material, such as HDPE.

The support/guide 1, also shown in the FIGS. 2A-E, comprises a base part 2 and a support part 4, which are connected to each other by an intermediate part 3. The intermediate part 3 is narrowed down with respect to the base part 2 and the support part 4.

The support part 4 has a support surface 14 for immediate support of the upper wall of a slat 400 (see FIGS. 2B and 2C). The slat 400, is in a manner known per se, U-shaped with upper wall 401, side walls 402 and turned lower flanges 403. The lower flanges 403 engage about and under the support part 4, as shown in FIG. 2C. The lower surface of the upper wall 401 supports slidingly on the upper surface 14 of the guide 1. In longitudinal view, see FIG. 2A, the support part 4 is extended by triangular end parts 11, in order to increase the dimension in longitudinal direction of the support surface 14.

Through the support part 4—in this example two—holes 12 have been arranged (optionally one hole is also possible), which extend through intermediate part 3 and base part 2 in order to open in openings 13a, 13b in the lower surface of the guide 1. The holes 12 are situated on either side of a centre (see FIG. 2B) of the guide 1. The holes 12 are suitable for passage of attachment means, such as bolts, which in that case extend through the bottom openings 13a, 13b (also see FIG. 2D). The edge of the openings 13a, 13b may be provided with a protruding centring cam 16, see FIGS. 2D and 2F.

The base part 2 has a support wall 5 which is intended to support on the upper surface of a cross beam, and which is provided with ribs 6. The ribs 6 are transverse to the longitudinal direction of support part 4.

At opposite edges the wall 5 changes into pendent placement or confinement strips 7, 8 wherein the placement strip 8 at the bottom is turned into a flange 9. The placement strips 7, 8 and flange 9 with the upper wall 5 define an inner space 10 for accommodation of the upper wall of a cross beam, as shown in the FIGS. 5 and further. The flange 9 is provided with a recess 15 for making pop rivets possible for the attachment of the guide on the cross beam. It is noted that also the placement strip 7 can be provided with such a flange 9, which in that case with the other flange defines a passage for preferably fitting accommodation of the web of a cross beam.

The other exemplary embodiment of a slat support/guide according to the invention shown in FIG. 3, has reference number 101, and is substantially formed and manufactured similarly, yet is distinct in that now instead of continuous attachment holes 12—in this example—two snap cams 109a, 109b have been integrally formed on the wall 105 of the base part 102. The snap cams 109a, 109b each comprise four (in this example) resilient snap lips 110a-d that are separated from each other by slits. The snap lips 110a-d have been provided with a shoulder 111. The snap lips 110a-d are surrounded by a passage 112 in the bottom wall 105 in which, after placement of the guide on a cross beam, if so desired a locking pin can be inserted to prevent the snap lips from moving towards each other.

In the FIGS. 5 and 6 the main set-up of a floor according to the invention is shown. Shown are usually steel longitudinal girders 200, for instance of a centre frame loading floor, for instance of a truck. The main girders 200 form the main part of the chassis. At regular intervals in longitudinal direction, continuous, usually steel, cross beams 300 have been placed, in which sections 300a, 300b and 300c can be distinguished. Beforehand the main girders 200 have been fittingly cut out so as to let the cross beams 300 extend through the main girder 200. At the location of the transitions of the sections 300a/b and 300b/c the cross beam 300 is welded to the webs 203 of the main girders 200. With their lower flange 302 the cross beams 300 are situated above the lower flange 202 of the main girders 200, and with the upper surface of their upper flange 301 just below the lower surface of the upper flange 201 of the main girder 200.

At regular intervals, see FIG. 5, guides 1 have been placed on the upper flange 301 of the cross beams 300. In that case the guide is manipulated such that together with flange 9 it is hooked below the upper flange 301, and subsequently the guide 1 is slid over the cross beam, wherein the upper flange enters the inner space 10. Finally the guide 1 with confinement strip 7 is pressed over the opposite edge of the upper flange 301. The upper flange 301 is then confined in a fitting manner between the confinement strips 7 and 8, as shown in FIG. 7. Beforehand a hole has been drilled in the one half of the flange 301 and/or in the other half thereof, which hole will have to be in line with the holes 12a,b in the guide 1, so that attachment means, such as bolts or rivets, can be passed through for securing the position of guide 1 on the cross beam 300, in longitudinal direction thereof. For facilitating the placement of the guide 1 the openings 13a,b may have been provided with said protruding centring cam 16 that fits exactly in the hole made.

Alternatively it is possible to place the guide 1 first on the upper flange of the cross beam and then to drill a hole using a drill passing through the holes 12, and subsequently to arrange the rivet and the like.

After attachment of the guide, the upper flange 300 abuts the lower side of the ribs 6 with the upper surface 301a, and the lower surface 301b abuts the upper side of the flange 9.

At the location of the main girders 200 adapted guides 1′ are attached to the upper flange 201, wherein the height of the upper surfaces of the guides 1 and 1′ is equal, and the same applies to the intervals between the guides 1 and 1′.

In the mounted condition of the guides 1, as can be seen in FIG. 6, the support parts 4 of the guides 1 extend entirely above the level of the upper surface 201a of the upper flange 201 of the main girders 200. The slats 400 can be shifted on the guides 1 forming a series of support points in the longitudinal direction of the main girders 200. This can be effected for adjacently situated slats, in the direction perpendicular to the plane of the drawing of FIG. 5. All cross beams, at least nearly all cross beams of a floor can be provided with guides in this way.

In the alternative embodiment shown in FIG. 8 no lip is hooked, yet the guide 101 is placed from above on the upper flange 301 of the cross beam 300. In that case (in this example) two holes have been arranged beforehand in the upper flange 301. With the lower end of the snap cams 109a, 109b the guide 101 is pressed on the edges of said holes. Subsequently a downward force is exerted onto the guide 101, as a result of which, due to the inclined walls of the lower ends of the snap cams 109a,b, the snap members 110a-d spring towards each other, made possible by the slits. Finally the shoulders 111 come from under the holes in the upper flange 301, and the snap lips 110a-d may spring away from each other again. The upper flange 301 is then confined between the lower side of the ribs 106 and the shoulders 111 of the snap cams 109a,b. In this way the guide 101 is clamp-fixedly attached to the cross beam 300. Additional connection means are not necessary then in most cases, although it is possible to place a locking pin in the passage 112, as discussed.

1. Floor of loading, unloading and/or storage spaces, for instance of trucks, comprising a number of slats that are reciprocally movable in loading/unloading direction by means of a drive, a series of cross beams supporting the slats and a number of fixedly positioned main girders extending in the loading/unloading direction and supporting the floor with drive, wherein the cross beams have an upper surface situated below the upper surface of the main girders, wherein series of support/guides for the slats have been attached to the cross beams, wherein the support/guides hold the slats with the lower side of the slats above the upper surface of the main girders.

2. Floor according to claim 1, wherein the cross beams have an upper wall, of which the upper surface is situated below the lower surface of an upper wall of the main girder.

3. Floor according to claim 1, wherein the cross beams extend beyond the main girders in transverse direction of the floor.

4. Floor according to claim 1, wherein the cross beams have a lower surface that is situated above the lower surface of the main girders.

5. Floor according to claim 1, wherein the support/guides each comprise a base part placed on the cross beam in question, a support part supporting the slat in question, as well as an intermediate part connecting the base part and the support part with each other, wherein preferably the base part, the intermediate part and the support part form one unity with each other, preferably are formed as one unity with each other.

6. Floor according to claim 4, wherein the support part is situated entirely above the upper surface of the main girders.

7. Floor according to claim 4, wherein the height of the base part with intermediate part is larger than the height of the support part.

8. Floor according to claim 4, wherein the slats form hollow profiles having an upper wall, side walls extending downward therefrom and lower flanges extending inward from the lower edge of the side walls, wherein the lower flanges extend below the support parts.

9. Floor according to claim 4, wherein the support part is widened with respect to the intermediate part in a direction transverse to the slats.

10. Floor according to claim 4, wherein the support part is widened with respect to the intermediate part in a direction parallel to the slats.

11. Floor according to any one of the preceding claims, wherein the cross beams have an upper wall having a lower surface, wherein the support/guides with integrally formed attachment members engage below the upper wall and against its lower surface.

12. Floor according to claim 11, wherein the integrally formed attachment members are designed for providing a snap action.

13. Floor according to claim 11, wherein the attachment members comprise a flange.

14. Floor according to claim 13, wherein the flange forms a U-shaped accommodation space in which at least a part of the upper wall of the cross beam has been accommodated.

15. Floor according to claim 13, wherein the support/guide is provided with two pendent confinement strips confining the upper wall of the cross beam between them, wherein the flange is integrally formed at one of the confinement strips.

16. Floor of loading, unloading and/or storage spaces for instance of trucks, comprising a number of slats that are reciprocally movable in loading/unloading direction by means of a drive, two fixedly positioned main girders extending in the loading/unloading direction and supporting the floor with drive and a series of cross beams supporting the slats, wherein the main girders comprise a vertical wall, such as a web of an I-girder, and the cross beams comprise portions that have been attached to either side of the vertical walls of the main girders, wherein the cross beams have an upper surface situated below the upper surface of the main girders, wherein each cross beam is provided with a separate series of support/guides for the slats, which support/guides have directly been attached to the upper surface of the cross beam in question and with a slat support surface extend above the upper surface of the main girders.

17. Floor according to claim 16, wherein the slats are situated entirely above the upper surface of the main girders.

18. Floor according to claim 16, wherein the support/guides are made from synthetic material, preferably by means of injection moulding.

19. Floor according to any one of the preceding claims, wherein the support/guides are single.

20. Floor according to claim 1, wherein the support/guides are formed like a joined (part) series in the longitudinal direction of the cross beam.

21. Support/guide for reciprocally movable slats, comprising a support part for a slat and a base part to be placed on a girder or beam of a loading, unloading or storage floor, wherein the base part at its lower side is provided with integrally formed attachment members for a snap connection in an attachment hole made in the girder or beam.

22. Support/guide according to claim 21, wherein the attachment members comprise a number of resilient snap lips.

23. Support/guide according to claim 22, wherein the attachment members have a passage for accommodation of a core locking the snap lips.

24. Support/guide for reciprocally movable slats, comprising a support part for a slat and a base part to be placed on a girder or beam of a loading, unloading or storage floor, wherein the base part at its lower side is provided with at least one lip for engaging about/below an upper flange or upper wall of the beam or girder.

25. Support/guide according to claim 24, provided with two oppositely oriented lips, which between them define a passage for the web of the beam or girder.

26. Support/guide for reciprocally movable slats, suitable and intended for a floor according to any one of the preceding claims.
